(19) United States
(12) Patent Application Publication
(10) Pub. No.: US 2025/0243914 A1
(43) Pub. Date: Jul. 31, 2025

(54) COMPOSITE BRAKE CALIPERS

(71) Applicant: GM GLOBAL TECHNOLOGY OPERATIONS LLC, Detroit, MI (US)

(72) Inventors: Cara Lynn Learman, Linden, MI (US); Mark T. Riefe, Brighton, MI (US); Tomasz R. Warzecha, Sterling Hts, MI (US); Benjamin Everest Slattery, Tecumseh (CA); James A. Webster, Bloomfield Hills, MI (US)

(73) Assignee: GM GLOBAL TECHNOLOGY OPERATIONS LLC, Detroit, MI (US)

(21) Appl. No.: 18/422,486

(22) Filed: Jan. 25, 2024

(51) Int. Cl. F16D 65/00; F16D 55/00

(52) U.S. Cl. CPC F16D 65/0068; F16D 2055/0016; F16D 2250/0015

(57) ABSTRACT

Composite brake calipers, vehicle with brake calipers, and methods for adjusting brake caliper stiffness are provided. A method for adjusting brake caliper stiffness for a vehicle includes determining a vehicle location envelope of a selected brake caliper; modeling a designed composite brake caliper to conform with the vehicle location envelope and to have an increased stiffness or to conform with a reduced vehicle location envelope; forming an insert component having a selected stiffness; and casting an exterior shell component around the insert component to form a composite brake caliper having the increased stiffness of the designed composite brake caliper and configured to fit within the vehicle location envelope or configured to conform with the reduced vehicle location envelope.

### INTRODUCTION

The disclosure relates to brake calipers for vehicles, and may in particular relate to brake calipers with increased stiffness for applying braking forces to disc brake rotors of a vehicle.

Motor vehicle disc brake systems typically utilize a disc brake rotor at each respective wheel, and each disc brake rotor typically includes a rotor hat for connecting to an axle hub of a rotatable axle of the motor vehicle, and at least one annular rotor cheek connected to the rotor hat, where the rotor cheek has a pair of mutually opposed braking surfaces onto which brake pads are selectively applied when braking is desired.

The disc brake system further typically includes calipers which support mutually opposed pair of brake pads, one brake pad disposed overlying a respective rotor cheek braking surface. Normally, the calipers keep the brake pads separated from the braking surfaces of the one or more rotor cheeks. Braking of the motor vehicle occurs by extending a caliper piston from the calipers to press the brake pads upon the braking surfaces of the rotor cheeks. Typically, a hydraulic fluid is used to cause the extension of the caliper piston. Frictional interaction between the rotating rotor cheeks and non-rotating brake pads causes braking of the motor vehicle, and the rate of braking depends upon the pressure of the brake pads against the braking surfaces.

Braking force may be limited by the stiffness or material strength of the brake calipers. Specifically, the calipers must withstand the outward forces of the caliper piston and the forces of the hydraulic fluid. Calipers with insufficient stiffness may leak hydraulic fluid and/or may undesirably extend away from one another during application of the brakes, thereby limiting the amount of braking force.

Also, brake squeal can be undesirably generated when braking occurs. Brake squeal is the result of modal excitations of the braking components by the frictional interaction during braking.

Accordingly, it is desirable to provide new and improved methods for adjusting brake caliper stiffness for vehicles, such as in automotive manufacturing, and for new and improved brake calipers having increased stiffness and/or desired natural frequencies. cost-effective and efficient methods for adjusting brake caliper stiffness for a vehicles. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method is provided for adjusting brake caliper stiffness for a vehicle. The method includes determining a vehicle location envelope of a selected brake caliper; modeling a designed composite brake caliper to conform with the vehicle location envelope and to have an increased stiffness or to conform with a reduced vehicle location envelope; forming an insert component having a selected stiffness; and casting an exterior shell component around the insert component to form a composite brake caliper having the increased stiffness of the designed composite brake caliper and configured to fit within the vehicle location envelope or configured to conform with the reduced vehicle location envelope.

In certain embodiments, the method includes modeling the designed composite brake caliper to conform with the vehicle location envelope and to have the increased stiffness; and casting the exterior shell component around the insert component to form the composite brake caliper having the increased stiffness of the designed composite brake caliper and configured to fit within the vehicle location envelope.

In certain embodiments, the method includes modeling the designed composite brake caliper to conform with the reduced vehicle location envelope; and casting the exterior shell component around the insert component to form the composite brake caliper configured to conform with the reduced vehicle location envelope.

In certain embodiments of the method, the exterior shell component includes aluminum, iron, aluminum alloy, or iron alloy. In certain embodiments of the method, the insert component includes a ceramic, a ceramic foam, a metal foam, an additive manufactured metal skeleton insert, a cast metal insert, a power metal insert, or a machined metal insert.

In certain embodiments of the method, casting the exterior shell component around the insert component to form the composite brake caliper includes: providing a mold; locating the insert component into the mold; pouring molten metal into the mold around the insert component; cooling the mold; and removing the composite brake caliper from the mold.

In certain embodiments of the method, the insert component includes passthroughs, and the exterior shell component includes pillars extending through the passthroughs.

In certain embodiments of the method, the insert component is less dense than the exterior shell component. In certain embodiments of the method, the composite brake caliper is less dense than the selected brake caliper.

In certain embodiments of the method, the selected brake caliper has a first natural frequency, and the composite brake caliper has an adjusted natural frequency greater than the first natural frequency.

In another embodiment, a brake caliper includes an exterior shell component having a first stiffness; and an insert component located within the exterior shell component, wherein the insert component has a second stiffness greater than the first stiffness.

In certain embodiments of the brake caliper, the exterior shell component includes aluminum, iron, aluminum alloy or iron alloy. In certain embodiments of the brake caliper, the insert component includes a ceramic, a ceramic foam, a metal foam, an additive manufactured metal skeleton insert, a cast metal insert, a power metal insert, or a machined metal insert.

In certain embodiments of the brake caliper, the insert component includes passthroughs, and the exterior shell component includes pillars extending through the passthroughs. In certain embodiments of the brake caliper, the exterior shell component is formed by casting a molten metal around the insert component.

In another embodiment, a vehicle includes wheels; and brakes configured to stop rotation of the wheels, wherein the brakes include brake calipers, and wherein each brake caliper includes: an exterior shell component having a first stiffness; and an insert component located within the exterior shell component, wherein the insert component has a second stiffness greater than the first stiffness.

In certain embodiments of the vehicle, the exterior shell component includes aluminum, iron, aluminum alloy or iron alloy. In certain embodiments of the vehicle, the insert component includes a ceramic, a ceramic foam, a metal foam, an additive manufactured metal skeleton insert, a cast metal insert, a power metal insert, or a machined metal insert.

In certain embodiments of the vehicle, the insert component includes passthroughs, and the exterior shell component includes pillars extending through the passthroughs. In certain embodiments of the vehicle, the exterior shell component is formed by casting a molten metal around the insert component.

### DESCRIPTION OF THE DRAWINGS

The present disclosure will hereinafter be described in conjunction with the following drawing figures, wherein like numerals denote like elements, and wherein:

FIG. 1 is a perspective view schematic of a vehicle having a braking system in accordance with exemplary embodiments;

FIG. 2 is a cross-sectional view schematic of a portion of the braking system of FIG. 1, in accordance with exemplary embodiments;

FIG. 3 is a perspective view schematic of a brake caliper of the braking system of FIG. 2, in accordance with exemplary embodiments;

FIG. 4 is a top view schematic of the brake caliper of FIG. 3;

FIG. 5 is an end view schematic of the brake caliper of FIG. 3;

FIG. 6 is a side view schematic of the brake caliper of FIG. 3; and

FIG. 7 is a flow chart illustrating a method for adjusting the stiffness of a brake caliper and/or for manufacturing a brake caliper, such as the caliper of FIGS. 2-7, in accordance with exemplary embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, brief summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Embodiments herein provide for providing brake calipers with increased stiffness, decreased density, and/or adjusted modal properties, while conforming with a given vehicle location envelope. As used, herein a “vehicle location envelope” of the caliper is the volume representing all positions which may be occupied by the caliper during its normal range of motion. The brake calipers provided herein achieve the desired properties through use of an insert component located inside of an exterior shell component to form a composite part. Specifically, a desired stiffness, a desired density, and/or a specific desired modal property may be identified and achieved by selecting and designing the insert component and modeling the composite part obtained by locating the insert component within the exterior shell component. In certain embodiments, the exterior shell component may be aluminum, aluminum alloy, iron, iron alloy, or other suitable cast metal. The insert component may be a ceramic; a ceramic foam; a metal foam; an additive manufactured metal skeleton insert; a cast metal insert; a power metal insert; a machined metal insert, such as steel; or another suitable material.

that provides the desired stiffness and has sufficient thermal properties to withstand the casting process.

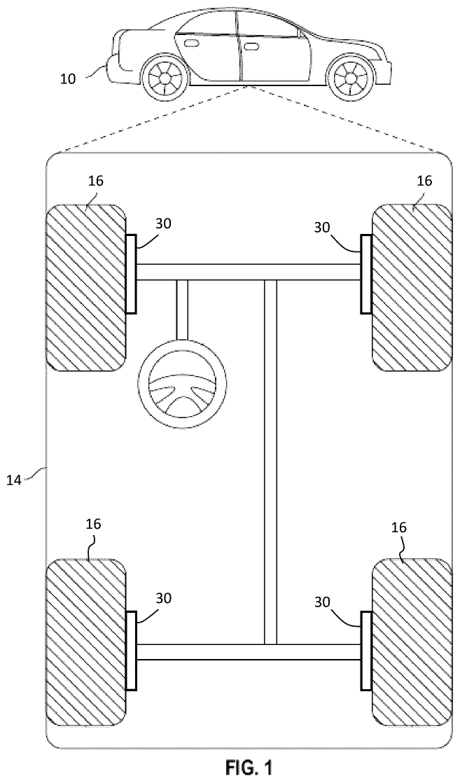

With reference to FIG. 1, certain features of a vehicle 10 are illustrated in functional block diagram form. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a body 14 and wheels 16. The body 14 substantially encloses components of the vehicle 10. The wheels 16 are each rotationally coupled to the vehicle 10 near a respective corner of the body 14.

As shown, the vehicle 10 includes a braking system 30 at each wheel 16.

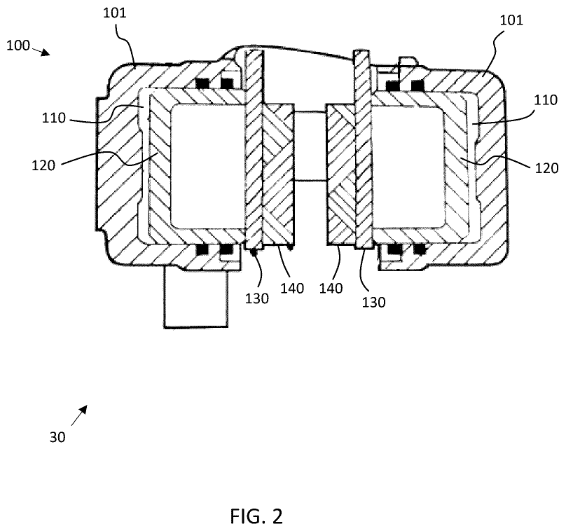

Referring to FIG. 2, the braking system 30 includes a brake caliper system 100. In the illustrated embodiment, the brake caliper system 100 includes two brake calipers 101, such as a mounting half and a rim half, though other possible embodiments are contemplated.

As shown, each brake caliper 101 is formed with a chamber 110. Further, a hydraulic piston 120 is located within each chamber 110. A pad backing plate 130 is to the end of each piston 120. Further, a brake pad 140 is mounted to the pad backing plate 130.

The pistons 120 are configured for movement toward one another such that the brake pads 140 may compress a rotor to slow rotation of the wheels. Further the pistons 120 are configured for movement away from one another to withdraw the brake pads 140 from the rotor. In order to drive movement of the pistons 120, a hydraulic fluid is injected into or removed from the piston chambers 110.

When the brake pads 140 contact the rotor, the forces may cause the brake calipers 101 to spread apart. Also, the forces may cause hydraulic fluid to leak from the piston chambers 110. In either case, the result is that some of the braking force generated by the foot pedal and master cylinder is wasted, and the braking force is limited. Long term results include increased pedal travel and tapered pad wear.

While FIG. 2 illustrates a braking system 100 with fixed brake calipers (often referred to as opposed piston calipers), other embodiments are contemplated. For example, the braking system 100 may include moving (often referred to as sliding or floating) brake calipers.

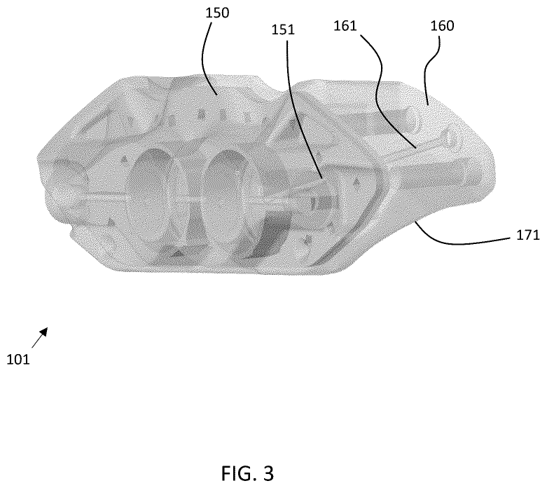

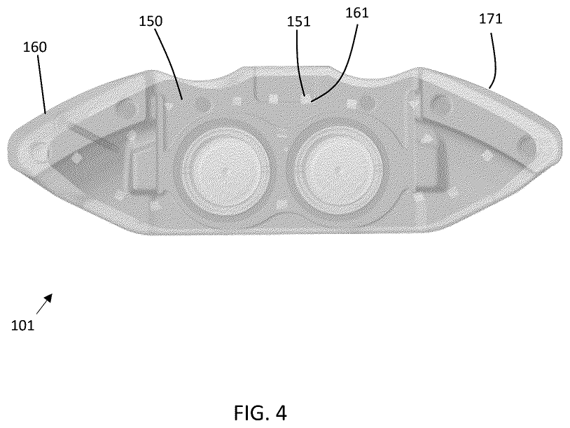

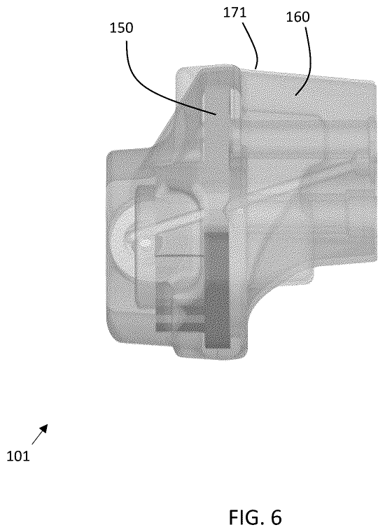

FIG. 3 is a perspective view of a brake caliper 101 with increased stiffness sufficient to withstand desired levels of braking forces. FIG. 4 is a top view, FIG. S is an end view, and FIG. 6 is a side view of the same brake caliper 101.

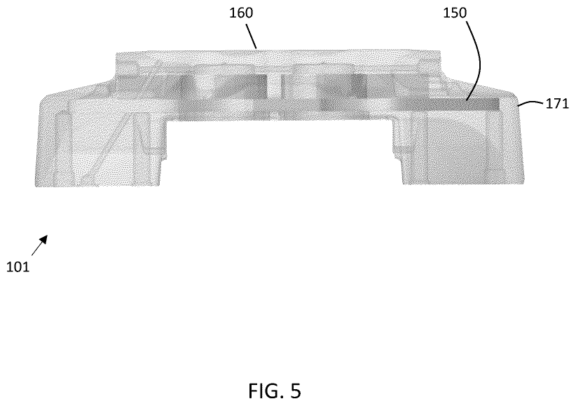

Cross-referencing FIGS. 3-6, the brake caliper 101 includes an insert component 150 and an exterior shell component 160.

The insert component 150 may be formed from a ceramic, from a metal foam, or from another suitable material providing sufficient stiffness and able to withstand the elevated temperatures of the manufacturing process described below.

The exterior shell component 160 may be formed via casting and may be a metal such as iron, iron alloy, aluminum, aluminum alloy, or other material suitable for use in a brake caliper 101. For example, the exterior shell component may be formed by casting a molten metal around the insert component 150.

In certain embodiments, the insert component 150 is less dense than the exterior shell component 160. Thus, the composite brake caliper 101 is less dense than an identically shaped and sized caliper formed only from the exterior shell component metal.

In certain embodiments, the insert component 150 has a greater stiffness than the exterior shell component 160.

In certain embodiments, the insert component 150 has a different natural frequency than the exterior shell component 160, such that the composite brake caliper 101 has an adjusted natural frequency that is different from the natural frequency of an identically shaped and sized caliper formed only from the exterior shell component metal.

The insert component 150 may be completely surrounded by the exterior shell component 160 such that the exterior shell component 160 forms the entire outer surface 171 of the composite brake caliper 101.

In certain embodiments, the insert component 150 includes passthroughs 151, i.e., channels or openings that extend through the insert component 150 from one side to the other. In such embodiments, the exterior shell component 160 includes pillars 161 that fill and extend through the passthroughs 151 and connect opposite sides of the exterior shell component 160.

The composite brake caliper 101 provides increased caliper strength and stiffness without increased section thickness and associated mass by casting in place a composite material within the caliper body. The increased stiffness without increased size allows the caliper to be used in a smaller envelope without negative impacts to fluid consumption/performance targets. Generally, strength measures the stress or force applied to a material before it breaks (tensile strength) or permanently deforms (yield strength). However, stiffness of material defines how a material bends to resist exerted force while returning to its original form upon removing the force. In certain embodiments, the composite brake caliper 101 is provided with increased stiffness, i.e., increased ability to resist deformation when an external force is applied, as compared to a non-composite unitary brake caliper of the same size and shape. In certain embodiments, the composite brake caliper 101 is provided with a higher Young's modulus, i.e., higher ratio of the ability to resist deformation to the ability to return to the original shape when the external force is removed, as compared to a non-composite unitary brake caliper of the same size and shape. In certain embodiments, the composite brake caliper 101 is provided with a higher yield strength, i.e., higher amount of force needed to permanently deform the caliper, as compared to a non-composite unitary brake caliper of the same size and shape. In certain embodiments, the composite brake caliper 101 is provided with a higher tensile strength, i.e., higher amount of tensile force needed to break the caliper, as compared to a non-composite unitary brake caliper of the same size and shape.

In addition to increased strength and stiffness, the selection and design of the insert component may be used to adjust the natural frequency of the composite brake caliper, as compared to a unibody caliper of the same shape and size. Specifically, the modal properties of the brake calipers, in terms of resonant frequencies, mode shapes, and structural damping, may be selected and achieved through selection and design of the insert component while still conforming to a given vehicle location envelope.

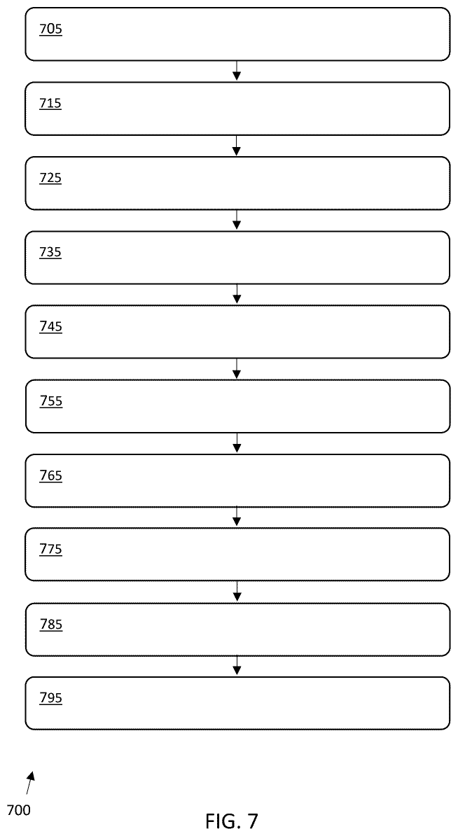

Referring to FIG. 7, a flow chart illustrates a method 700 for adjusting brake caliper stiffness for a vehicle. As shown, method 700 includes determining a parameter or parameters of a selected brake caliper at operation 705. For example, method 700 may determine a vehicle location envelope of the brake caliper. Method 700 may also determine the stiffness of a selected brake caliper. For example, the stiffness of a cast unibody caliper of a determined shape and size, i.e., non-composite caliper, may be determined by modeling, such as by a processor. Method 700 may also determine the natural frequency of a selected brake caliper. For example, the natural frequency of a cast unibody caliper, i.e., non-composite caliper, of a determined shape and size may be determined by modeling, such as by a processor.

Method 700 may continue at operation 715 with modeling a designed composite brake caliper to conform with, i.e., fit within, the vehicle location envelope. A processor may model the designed composite brake caliper. The designed composite brake caliper may have an increased stiffness, such as greater than the stiffness of the selected brake caliper. Additionally or alternatively, the designed composite brake caliper may conform with a reduced vehicle location envelope. For example, a proposed re-design or proposed use of other components of increased dimensions may suggest use of a reduced vehicle location envelope that is, at least partially, smaller than the original vehicle location envelope. Thus, the designed composite brake caliper may conform to a smaller vehicle location envelope while providing sufficient stiffness.

At operation 725, method 700 includes forming an insert component having a selected stiffness. As described above, the insert component may be a ceramic; a ceramic foam; a metal foam; an additive manufactured metal skeleton insert; a cast metal insert; a power metal insert; a machined metal insert, such as steel; or another suitable material.

Method 700 includes, at operation 735, providing a mold. Specifically, the mold may be designed and manufactured to form cast parts with a desired profile and size. In certain embodiments, the mold may be formed from sand or metal.

At operation 745, method 700 includes locating the insert component in the mold.

Then, method 700 includes, at operation 755, pouring molten metal into the mold and around the insert component. The molten metal may be iron, iron alloys, aluminum, aluminum alloys, or other suitable metal. It is noted that the insert component may include passthroughs, or channels that extend through the insert component, and that the molten metal may fill the passthroughs. Further, the insert component is not deformed or otherwise damaged by the heat of the molten metal.

At operation 765, the method includes cooling the mold. While cooling, the molten metal solidifies to form a cast exterior component surrounding the insert component, i.e., a molded composite part. Further, the cast exterior component may include pillars extending through the insert component.

After the metal solidifies to form the cast exterior component, method 700 includes removing the molded composite part from the mold at operation 775.

At operation 785, method 700 may include performing machine casting of the molded composite part to cut or remove material from the molded composite part to make the dimensions of the part more accurate, if necessary.

Operations 735, 745, 755, 765, 775, and/or 785 may collectively provide a process for casting an exterior shell component around the insert component to form a composite brake caliper having the increased stiffness of the designed composite brake caliper and configured to fit within the vehicle location envelope or configured to conform with the reduced vehicle location envelope.

Method 700 may further include, at operation 795, installing the composite brake calipers in a vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for adjusting brake caliper stiffness for a vehicle, the method comprising:
determining a vehicle location envelope of a selected brake caliper;
modeling a designed composite brake caliper to conform with the vehicle location envelope and to have an increased stiffness or to conform with a reduced vehicle location envelope;
forming an insert component having a selected stiffness; and
casting an exterior shell component around the insert component to form a composite brake caliper having the increased stiffness of the designed composite brake caliper and configured to fit within the vehicle location envelope or configured to conform with the reduced vehicle location envelope.

2. The method of claim 1, comprising
modeling the designed composite brake caliper to conform with the vehicle location envelope and to have the increased stiffness; and
casting the exterior shell component around the insert component to form the composite brake caliper having the increased stiffness of the designed composite brake caliper and configured to fit within the vehicle location envelope.

3. The method of claim 1, comprising:
modeling the designed composite brake caliper to conform with the reduced vehicle location envelope; and
casting the exterior shell component around the insert component to form the composite brake caliper configured to conform with the reduced vehicle location envelope.

4. The method of claim 1, wherein the exterior shell component comprises aluminum, iron, aluminum alloy, or iron alloy.

5. The method of claim 1, wherein the insert component comprises a ceramic, a ceramic foam, a metal foam, an additive manufactured metal skeleton insert, a cast metal insert, a power metal insert, or a machined metal insert.

6. The method of claim 1, wherein casting the exterior shell component around the insert component to form the composite brake caliper comprises:
providing a mold;
locating the insert component into the mold;
pouring molten metal into the mold around the insert component;
cooling the mold; and
removing the composite brake caliper from the mold.

7. The method of claim 1, wherein the insert component includes passthroughs, and wherein the exterior shell component includes pillars extending through the passthroughs.

8. The method of claim 1, wherein the insert component is less dense than the exterior shell component.

9. The method of claim 1, wherein the composite brake caliper is less dense than the selected brake caliper.

10. The method of claim 1, wherein the selected brake caliper has a first natural frequency, and wherein the composite brake caliper has an adjusted natural frequency greater than the first natural frequency.

11. A brake caliper comprising:
an exterior shell component having a first stiffness; and
an insert component located within the exterior shell component, wherein the insert component has a second stiffness greater than the first stiffness.

12. The brake caliper of claim 11, wherein the exterior shell component comprises aluminum, iron, aluminum alloy or iron alloy.

13. The brake caliper of claim 11, wherein the insert component comprises a ceramic, a ceramic foam, a metal foam, an additive manufactured metal skeleton insert, a cast metal insert, a power metal insert, or a machined metal insert.

14. The brake caliper of claim 11, wherein the insert component includes passthroughs, and wherein the exterior shell component includes pillars extending through the passthroughs.

15. The brake caliper of claim 11, wherein the exterior shell component is formed by casting a molten metal around the insert component.

16. A vehicle comprising:
wheels; and
brakes configured to stop rotation of the wheels, wherein the brakes comprise brake calipers, and wherein each brake caliper comprises:
an exterior shell component having a first stiffness, and
an insert component located within the exterior shell component, wherein the insert component has a second stiffness greater than the first stiffness.

17. The vehicle of claim 16, wherein the exterior shell component comprises aluminum, iron, aluminum alloy or iron alloy.

18. The vehicle of claim 16, wherein the insert component comprises a ceramic, a ceramic foam, a metal foam, an additive manufactured metal skeleton insert, a cast metal insert, a power metal insert, or a machined metal insert.

19. The vehicle of claim 16, wherein the insert component includes passthroughs, and wherein the exterior shell component includes pillars extending through the passthroughs.

20. The vehicle of claim 16, wherein the exterior shell component is formed by casting a molten metal around the insert component.
